(19) United States
(12) Patent Application Publication
(10) Pub. No.: US 2022/0316430 A1
(43) Pub. Date: Oct. 6, 2022

(54) LOW MELTING IRON BASED BRAZE FILLER METALS FOR HEAT EXCHANGER APPLICATIONS

(71) Applicant: OERLIKON METCO (US) INC., Westbury, NY (US)

(72) Inventors: Dongmyoung LEE, Novi, MI (US); Subramaniam RANGASWAMY, Rochester Hills, MI (US)

(73) Assignee: OERLIKON METCO (US) INC., Westbury, NY (US)

(21) Appl. No.: 17/641,941

(22) PCT Filed: Oct. 9, 2020
(86) PCT No.: PCT/US2020/055026

§ 371 Date: Mar. 10, 2022

Related U.S. Application Data
(60) Provisional application No. 62/929,370, filed on Nov. 1, 2019.

(51) Int. Cl. F02M 26/11; B23K 35/30; B23K 1/00; F02M 26/29

(52) U.S. Cl. CPC F02M 26/11; B23K 35/3066; B23K 1/0012; F02M 26/29; B23K 2101/14

(57) ABSTRACT

Iron-based braze filler alloys having unexpectedly narrow melting temperature ranges, low solidus and low liquidus temperatures, as determined by Differential Scanning calorimetry (DSC), while exhibiting high temperature corrosion resistance, good wetting, and spreading, without deleterious significant boride formation into the base metal, and that can be brazed below 1,100 C contains a) nickel in an amount of from 0% to 35% by weight, b) chromium in an amount of from 0% to 25% by weight, c) silicon in an amount of from 4% to 9% by weight, d) phosphorous in an amount of from 5% to 11% by weight, e) boron in an amount of from 0% to 1% by weight, and f) the balance being iron, the percentages of a) to f) adding up to 100% by weight. The braze filler alloys or metals have sufficient high temperature corrosion resistance to withstand high temperature conditions of Exhaust Gas Recirculation Coolers.

### CROSS-REFERENCE TO RELATED APPLICATION

This International Application claims the benefit of U.S. Provisional Application No. 62/929,370 filed Nov. 1, 2019, the disclosure of which is expressly incorporated by reference herein in its entirety.

### FIELD OF THE INVENTION

The present invention relates to low melting iron based braze filler metals with high temperature corrosion resistance. The braze filler metals or alloys may be in the form of a powder, amorphous foil, atomized powder, paste, tape, or sintered preform, and may be employed in powder spray coatings with a binder for spraying applications, and screen printing pastes for screen printing. The braze filler metals may be used for brazing of heat exchangers, or in the production of heat exchangers, such as Exhaust Gas Recirculation Coolers (EGR coolers) that aid in reducing nitrogen oxide emissions (NOx) for internal combustion engines, and other devices which are employed in high temperature corrosive environments.

### BACKGROUND OF THE INVENTION

Iron-chromium based braze filler metals have been known for brazing of stainless steels, alloy steels, carbon steels. Many of the currently known Fe based braze filler metals (BFM) have significant cost advantages over nickel based BFM's. However, their widespread use in applications such as plate heat exchangers, EGR coolers, catalytic converters have not been successful due to their relatively high melting points and therefore very high braze temperatures well in excess of 1,100° C.

Boron in amounts of between 2% by weight and 4% by weight as an alloying element in filler metals has been used to depress the melting point of BFMs. However, this is not desirable in thin structured base metals due to the erosion problems caused by high boron content where boride formation occurs along grain boundaries.

U.S. Pat. No. 7,392,930 to Rangaswamy et al discloses that several different grades of nickel-based braze filler metals are defined by the American Welding Society (ANSI/AWS A 5.8) standard, and are used in the fabrication of heat exchangers. According to Rangaswamy et al, BNi-2, is an exemplary nickel-based brazing filler with a nominal composition of Ni-Bal, Cr-7, B-3, Si-4.5, Fe-3 which is a well-known filler metal capable of producing braze joints with high strength. However, it is disclosed, a major disadvantage of this filler metal is the degradation of the strength of the base metal due to significant boride formation into the base metal especially in thin sheet metals as in heat exchangers, and erosion of the base metal. Other boron-containing nickel-based filler metals (such as, for example, BNi-1, BNi-1A, BNi-3, BNi-4 and BNi-9), it is disclosed, have similar disadvantages due to the high amounts of boron of nearly 3 wt % percent.

To overcome the disadvantages of the boron containing braze filler alloys, other alloys without boron have been considered, such as BNi-6 (Ni-10P), BNi-7 (Ni-14Cr-10P) alloys, which contain approximately 10 percent phosphorus, but they produce joints without the required strength due to brittle phases in the joint. Another boron-free nickel-based braze alloy is BNi-5 (a Ni-Bal; Cr-19, Si-10). However, according to Rangaswamy et al, while these alloys were excellent in producing joints without the deleterious effect of significant boride formation into the base metal, there were other disadvantages. These disadvantages would include the liquidus temperature being significantly higher than 1,100° C.

Rangaswamy et al disclose iron-based braze filler metal compositions for high-temperature applications which have melting points lower than 1,200° C. Phosphorus and silicon contents are melting point depressants, however, according to Rangaswamy et al, excess amounts of these elements increase the brittleness of the joints, but there must be enough of these elements to help reduce the melting point to around 1,100° C. Therefore, the amount of phosphorus and silicon will each generally not exceed about 12 wt %. The Rangaswamy et al brazing filler metal compositions include chromium in amounts between about 20 to 35 percent by weight, silicon in amounts between about 3 to 12 percent by weight, phosphorus in amounts between about 3 to 12 percent by weight; and 0 to about 0.2 weight percent of one or more of calcium, yttrium and misch metal, the balance being iron. Boron is not employed in the compositions.

U.S. Pat. No. 4,410,604 to Pohlman et al discloses an iron-based brazing filler alloy composition with a flow temperature of under 2,200° F., preferably less than 2,100° F., which contains less than or equal to 40 wt % nickel, preferably 18 to 22 wt %; 2 to 20 wt % percent chromium; 0 to 5 wt % boron, for example 2 to 5 wt % boron; 5 to 12 wt % silicon; a maximum of 0.5 wt % carbon; and at least 50 wt % iron. The use of phosphorus is not disclosed.

U.S. Patent Application Publication No. 2011/0014491 to Mars et al discloses iron-chromium based brazing filler metal powder which comprises: between 11 and 35 wt % chromium, between 0 and 30 wt % nickel, between 2 and 20 wt % copper, between 2 and 6 wt % silicon, between 4 and 8 wt % phosphorous, between 0-10 wt % manganese, and at least 20 wt % iron. According to Mars et al, phosphorus can form brittle phases which causes loss of strength, when employed in high amounts of 10 wt %. The presence of boron in nickel based brazing filler metal is, however, a disadvantage according to Mars et al because it may cause embrittlement of the base material when boron is diffused into the base material. Mars et al discloses that an iron based brazing filler metal, AMDRY805, described in US-application US20080006676 A1 has the composition Fe-29Cr-18Ni-7Si-6P, and it is boron free to overcome the disadvantage with boron. The braze temperature for this alloy is above 1104° C. According to Mars et al, the highest practical temperature consistent with limited grain growth is 1095° C., according to ASM specialty hand book Stainless Steel, 1994, page 291. Therefore a low brazing temperature is preferred to avoid the problems associated with grain growth, such as worsened ductility and hardness, in the base material. The Mars et al brazing filler metal it is disclosed, has a melting point below 1,100° C. and produces joints at a brazing temperature of 1,120° C. having high strength and good corrosion resistance without any observed grain growth.

U.S. Patent Application Publication No. 2010/0055495 to Sjödin discloses an iron based brazing material comprising an alloy essentially containing 15 to 30 wt %, chromium (Cr), 0 to 5.0 wt % manganese (Mn), 9 to 30 wt % nickel (Ni), 0 to 4.0 wt % molybdenum (Mo), 0 to 1.0 wt % nitrogen (N), 1.0 to 7.0 wt % silicon (Si), 0 to 0.2 wt % boron (B), 1.0 to 7.0 wt % phosphorus (P), optionally 0.0 to 2.5 wt % of each of one or more of elements selected from the group consisting of vanadium (V), titanium (Ti), tungsten (W), aluminum (Al), niobium (Nb), hafnium (Hf) and tantalum (Ta); the alloy being balanced with Fe, and small inevitable amounts of contaminating elements; and wherein Si and P are in amounts effective to lower melting temperature. According to Sjödin a high brazing temperature is quite often associated with high mechanical strength or other properties that are of importance for the braze joint, but it also has some disadvantages, such as a decrease in the properties of the base material, by e.g. grain growth, formation of phases in the material, a large impact from the braze filler into the base material by diffusion of elements from the filler to the base material, and erosion of the base material. Boron, it is disclosed, has a quite large impact on lowering the melting point but has a lot of disadvantages, such as formation of chromium borides which decreases the amount of chromium in the base material, which then e.g. decreases the corrosion resistance and other properties of the base material. Therefore, according to Sjödin, when chromium is one of the elements of the alloy, then no or very small amounts of boron are generally the best choice. The brazing material of Sjödin it is disclosed, has a temperature range between the solidus state and the liquidus state, which according to various aspects may be within a temperature range of 50° C. or within a much wider temperature range of 200° C. Solidus temperatures ranging from 1,055° C. to 1,060° C. and liquidus temperatures ranging from 1,092° C. to 1,100° C. with temperature differences of 32° C. to 45° C., are disclosed for various brazing compositions. The differences between the solidus and liquidus temperatures, it is disclosed, are surprisingly narrow. However, the liquidus temperatures themselves are high, being at least 1,092° C., which indicates high brazing temperatures.

U.S. Pat. No. 4,402,742 to Pattanaik discloses an iron-nickel base brazing filler alloy consisting essentially of from about 1 to about 5 wt % of boron, from about 3% to about 6 wt % of silicon from 0 to about 12 wt % of chromium, from about 1 to about 45 wt % of nickel, and balance iron. The brazing alloy has a maximum liquidus temperature of about 1,130° C. Various alloy compositions are disclosed with solidus temperatures ranging from 940° C. to 1,156° C. and liquidus temperatures ranging from 1,010° C. to 1,174° C. According to Pattanaik, while in general, the boron content in the alloys can vary from about 1 to about 5 wt %, boron lowers the liquidus temperature of the resulting alloy, hence the higher the level of boron the lower the liquidus temperature of the brazing alloy up to about 4% by weight and then the liquidus temperature increases. Silicon, it is further disclosed, also lowers the liquidus temperature in the iron base, B—Si—Cr—Ni—Fe system, however the effect is not as pronounced as for boron and the amount of silicon used varies from about 3 to about 6 wt %. Nickel depresses the liquidus temperature of the B—Si—Ni—Fe and of the B—Si—Cr—Ni—Fe systems, and the amount of nickel preferred by Pattanaik is 20 to 40 wt %. According to Pattanaik, increasing the chromium level will increase the liquidus temperature in the B—Si—Cr—Ni—Fe system, and about 12 wt % of chromium is all that can be utilized and have a liquidus temperature below about 1,130° C. provided the B and Si are the recited levels. Phosphorus is not employed in the brazing alloy.

U.S. Pat. No. 6,656,292 to Rabinkin et al discloses iron/chromium brazing filler metals which consist essentially of a composition having the formula FeₐCr_{b}Co_{c}Ni_{d}MoₑW_{f}B_{g}Siₕ, wherein the subscripts “a”, “b”, “c”, “d”, “e”, “f”, “g”, and “h” are in at % and wherein, “b” ranges from about 5 to 20, “c” ranges from 0 to about 30, “d” ranges from 0 to about 20, “e” ranges from 0 to about 5, “f” ranges from 0 to about 5, “g ranges from about 8 to 15, and “h” ranges from about 8 to 15. According to Rabinkin et al the alloys contain substantial amounts of boron and silicon, which are present in the solid state in the form of hard and brittle borides and silicides, making the alloys especially suited for fabrication into flexible thin foil by rapid solidification techniques. Various alloys are disclosed which have solidus temperatures of 1,110° C. to 1,144° C. and liquidus temperatures of 1,162° C. to 1,196° C. as determined by Differential Thermal Analysis (DTA) techniques. Phosphorus is not employed in the brazing alloy.

U.S. Patent Application Publication No. 2006/0090820 to Rabinkin et al discloses a brazing filler metal consisting essentially of a composition with a formula FeₐCr_{b}B_{c}Si_{d}Xₑ, wherein X is molybdenum, tungsten, or a combination of molybdenum and tungsten, and incidental impurities, wherein the subscripts “a”, “b”, “c”, “d”, “e” are all in at %, and wherein “b” is between about 0 and 5, “c” is between about 10 and about 17, “d” is between about 4 and about 10, “e” is between about 0 and about 5, and a sum “a”+“b”+“c”+“d”+“e” is approximately equal to 100. According to Rabinkin et al, nickel-based brazing filler metals include a significant proportion of nickel, and nickel-based brazing filler metals are believed to be the source of undesired nickel leachate. For this reason, use of nickel-based brazing filler metals it is disclosed, should be avoided in applications where nickel leaching into a fluid presents a concern, as is the case when materials passing through the heat exchangers are to be used for human ingestion or consumption. Various alloys are disclosed which have solidus temperatures of 1,042° C. to 1,174° C. and liquidus temperatures of 1,162° C. to 1,182° C. as determined by Differential Thermal Analysis (DTA) techniques. The boron content calculates to be more than 2.7 wt %, and phosphorus is not employed in the brazing alloy.

Hong, Li et al, “The effect of iron-based filler metal element on the properties of brazed stainless steel joints for EGR cooler application,” Welding in the World (2019) 63:263-275, published online Dec. 14, 2018 discloses that as an alternative to the traditional nickel-based filler metals, new-type of iron-based filler metal has become a development trend for stainless steel brazing in exhaust gas recirculation (EGR) cooler fabrication, aiming at decreasing brazing temperature and obtaining higher joint strength with minimal erosion as well as better corrosion resistance. The effect of B and Mo content on interface microstructure, lap-joint shear strength, microhardness, and corrosion resistance of a brazed seam was investigated. According to Hong et al, the optimum brazing parameters were achieved at 1,050° C.-20 min. and both brazing temperature and holding time are critical factors for controlling the interface microstructure and hence the mechanical properties of the brazed joints. Hong et al discloses that previous efforts focused on the boron-free iron-based filler metals such as typical, BrazeLet F300 (Fe-24Cr-20Ni-5Si-7P) from Höganäs (Sweden) and Amdry 805 (Fe-29Cr-18Ni-7Si-6P) from Sulzer: (Switzerland) Inc., and the brazing temperatures of these two filler metals are 1,100° C. and 1,176° C., respectively.

Other commercially available boron-free iron-based brazing metals include TB-4520, a 45Fe-20Ni-20Cr-2Mo-7P-6Si braze alloy of Tokyo Braze, Inc., which contains Mo, and because of its melting range of 1,030° C.-1,085° C., the recommended brazing temperature of the alloy is 1,120° C. to 1,140° C. BrazeLet F300-10(Fe-20Ni-20Cr-4Si-7P-10Cu) for vacuum brazing, and F300-20(Fe-20Ni-20Cr-4Si-7P-6.5Cu) for belt furnace applications, both products of Höganäs (Sweden) contain Cu and are believed to have a melting range of 1,000° C. to 1,070° C. with a recommended brazing temperature of 1,120° C. or above in a vacuum or a controlled atmosphere. FP-641 of Fukuda Metal Foil Powder Industry Co. Ltd. is a boron-free iron-based brazing metal containing Cu and Mo with a composition of Fe-15Ni-18Cr-5Si-6.5P-2Cu-2Mo, and a melting temperature range of 1,030° C. to 1,060° C.

However, according to Hong et al, iron-based filler metals with the addition of Cu, Mo, Ti, or rare earth elements in order to increase corrosion resistance or obtain joints with high ductility also have high brazing temperatures ranging from 1,110° C. to 1,160° C. However, considering the effect of grain growth of stainless steel on the ductility and hardness at high temperatures, it is disclosed, the maximum brazing temperature is 1,095° C., according to ASM specialty handbook Stainless Steel, and the rate and depth of erosion can increase by increasing the brazing temperature. According to Hong et al, if the brazing temperature is too high, iron-based filler metals have a tendency to erode stainless steel more than traditional nickel-based alloys. Further, it is disclosed, excess erosion/dissolution of solid substrate in molten filler can result in iron reacting with nickel to generate FeNi₃ compounds in brazed joints, which deteriorate the parent material properties and decrease the joint strength.

According to Hong et al, with iron-based filler metals containing melting point depressant elements including boron (B), silicon (Si), and phosphorus (P), the boron increases the risk of embrittlement of the brazed joints because boron atoms appear to diffuse into the lattice of the base metals, resulting in brittle precipitations of CrB phase, and the addition of boron needs to precisely adjusted. Copper (Cu) is employed to reduce diffusion of silicon and phosphorous into the base metals and to improve corrosion resistance. Molybdenum (Mo) is included to improve wettability and to enhance joint strength and reduce erosion. Chromium (Cr) which is required for corrosion resistance is limited to 12 wt %. Nickel (Ni), which enhances oxidation resistance of the filler alloy and increases strength of the brazed joint is maintained at 20 wt %. In the Hong et al iron-based filler metals, the contents of nickel, chromium, copper, silicon, and phosphorus elements were kept unchanged at 20, 12, 3, 4, and 7 (in wt. %), respectively. In one group of filler metals, the Mo content is maintained at 3 wt %, and the B content increases from 0 to 1 wt %. In another group of filler metals the B content is maintained at 0.25 wt % and the Mo element increases from 0.5 to 4 wt %. It is reported that in a composition without B and without Mo, (for example 54Fe-20Ni-12Cr-3Cu-4Si-7P, in weight percent) the solidus temperature is 895° C. and the liquidus temperature is 1,006° C. with a melting range of 111° C., as determined by DSC thermal measurement instruments during the heating or cooling process. However, it is reported that in a composition with 1 wt % B and 3 wt % Mo, and 50 wt % Fe instead of 54 wt % Fe (50Fe-20Ni-12Cr-3Cu-4Si-7P-1B-3Mo in weight percent) the solidus temperature is 900° C. and the liquidus temperature is 952° C. with a melting range of 52° C., as determined by the DSC thermal measurement instruments.

Hong et al indicates that according to the DSC test, it can be determined that the recommended brazing temperature could be reduced to 1,050° C. According to Hong et al when there is no element B there are more than one eutectic structures or both eutectic and non-eutectic structures in the microstructure of the filler metal. The alloy which does not contain element B or Mo (54Fe-20Ni-12Cr-3Cu-4Si-7P in weight percent) results in a different crystal phase and the phase transition temperature is different. There are two peaks in the thermal analysis results, and according to Hong et al the multi-peak phenomenon in the 54Fe-20Ni-12Cr-3Cu-4Si-7P brazing metal is unfavorable to the brazing seam filling process. The two melting temperature range values, it is disclosed, gives a melting range of the entire brazing alloy which is too wide, which is not conducive to the rapid spread of filler metal during brazing, which indicates that the design of the filler metal composition is unreasonable. The DSC curve of the filler metal with B and Mo, (54Fe-20Ni-12Cr-3Cu-4Si-7P in weight percent), has only one peak according to Hong et al, indicating that almost all of them are uniform, single eutectic structures, and the melting temperature range of the filler metal is narrow and the melting temperature is relatively low, and therefore, the filler metal has good fluidity and is beneficial to the filling process.

According to Hong et al, the addition of the elements Mo in an amount of 3 wt % and B in an amount of 1 wt % did not cause the DSC curve to be multimodal, but instead narrowed the melting temperature range of the filler metal alloy, which was conducive to the rapid melting of the filler metal on the base metal, and also lowered the liquid is temperature to 952° C. After a series of tests, based on the results the optimal composition of the iron-based filler metal named BJUT-Fe (50.75Fe-20Ni-12Cr-3Cu-4Si-7P-0.25B-3Mo in weight percent) was determined and according to Hong et al is almost identical (the B being lowered from 1 to 0.25 wt %, and the Fe being raised to 50.75 from 50 wt %). According to Hong et al, the addition of B and Mo narrowed the melting range and lowered the liquid is temperature so that brazing can be performed at a remarkable lower temperature of 1,050° C.

In contrast, to overcome the above problems, the present invention provides iron-based braze filler metals having unexpectedly narrow melting temperature ranges, low solidus temperatures, and low liquidus temperatures, even if two phases or peaks are present, as determined by Differential Scanning calorimetry (DSC), while exhibiting high temperature corrosion resistance, good wetting, and good spreading, without the deleterious effect of significant boride formation into the base metal. It is not necessary to lower the chromium content, and to add Cu, Mo, Ti, or rare earth elements to increase corrosion resistance or obtain joints with high ductility. Also, nickel contents of the iron-based braze filler metals provide mechanical strength with substantially lowering of the solidus and liquidus temperatures to achieve low brazing temperatures and strong bonding to the base metal, and corrosion resistance. No, or very low amounts of boron are employed to avoid significant boride formation. The braze filler metals or alloys may be in the form of a powder, amorphous foil, atomized powder, paste, tape, or sintered preform, and may be employed in powder spray coatings with a binder for spraying applications, and screen printing pastes for screen printing. The braze filler metals may be used for brazing of heat exchangers, or in the production of heat exchangers, such as Exhaust Gas Recirculation Coolers (EGR coolers) that aid in reducing nitrogen oxide emissions (NOx) for internal combustion engines, and other devices which are employed in high temperature corrosive environments. Additionally, brazing may be performed at low temperatures while achieving rapid melting of the filler metal on the base metal.

### SUMMARY OF THE INVENTION

In accordance with the present invention, iron-based braze filler alloys or metals which provide unexpectedly low melting points, a narrow melting range, and high temperature corrosion resistance, and that can be brazed below 1,100° C., with no or very low amounts of boron, comprise iron, phosphorus, and silicon, without the need for copper or molybdenum, titanium, or rare earth elements to increase corrosion resistance or obtain joints with high ductility. Nickel and chromium are preferably employed to increase high temperature corrosion resistance while lowering or without any substantial increasing of the melting point of an iron, phosphorus, and silicon ternary alloy. Micro-alloying with very small amounts of boron may be employed to further improve brazeability and reduce melting points without deleterious embrittlement and erosion caused by boron diffusion into the base metal.

The iron-based braze filler alloy or metals of the present invention comprise:
a) nickel in an amount of from 0 to 35 wt %, generally at least 10% by weight, for example from 25 wt % to 35 wt %, preferably from 28 wt % to 33 wt %, more preferably from 29 wt % to 32 wt %, most preferably from 29 wt % to 31 wt %,
b) chromium in an amount of from 0 wt % to 25 wt %, generally at least 10 wt %, for example from 18 wt % to 25 wt %, preferably from 18 wt % to 23 wt %, more preferably from 18 wt % to 22 wt %, for example, from 19 wt % to 21 wt %,
c) silicon in an amount of from 4 wt % to 9 wt %, for example from 4 wt % to 6 wt %, preferably from 4.5 wt % to 6 wt %, more preferably from 5 wt % to 6 wt %,
d) phosphorous in an amount of from 5 wt % to 11 wt %, preferably from 5 wt % to 10 wt %, more preferably from 6 wt % to 10 wt %,
e) boron in an amount of from 0 wt % to 1 wt %, preferably greater than 0 wt % but less than 1 wt %, for example from 0.1 wt % to 0.8 wt %, preferably from 0.1 wt % to 0.5 wt %, more preferably from 0.3 wt % to 0.5 wt %, for example from 0.3 wt % to 0.4 wt %, and
f) the balance being iron, for example from 29 wt % by weight to 60 wt % by weight, preferably from 29 wt % by weight to 40 wt % by weight, more preferably from 29 wt % by weight to 35 wt % by weight, most preferably from 29 wt % by weight to 33 wt % by weight,
   the percentages of a) to f) adding up to 100% by weight. The total amount of iron, nickel, and chromium is from 84 wt % to 90 wt %, the ratio of a/(a+f) is from 0 to 0.5, for example from 0.2 to 0.5, preferably from 0.3 to 0.5, more preferably from 0.4 to 0.5, and the ratio of b/(a+b+f) is from 0 to 0.33, preferably from 0.1 to 0.3, more preferably from 0.15 to 0.3, for example from 0.20 to 0.26.

The iron-based braze filler alloy has at least one of:
1. a solidus temperature which is less than or equal to 1,030° C., preferably less than or equal to 1,000° C., most preferably less than or equal to 975° C.,
2. a liquidus temperature which is less than or equal to 1,075° C., preferably less than or equal to 1,050° C., or
3. a melting range where the difference between the solidus temperature and the liquidus temperature is less than 85° C., preferably less than or equal to 50° C., more preferably less than or equal to 25° C.
   In embodiments of the invention, the iron-based braze filler alloy has a brazing temperature of less than 1,100° C., preferably less than 1,060° C., more preferably less than 1,050° C., and the brazing temperature is from 25° C. to 50° C. higher than the liquidus temperature. The brazing may be performed at low temperatures while achieving rapid melting of the filler metal on the base metal.

In aspects of the invention, the braze filler metals or alloys may be in the form of a powder, amorphous foil, atomized powder, paste, tape, or sintered preform.

The braze filler metals or alloys may be employed in powder spray coatings with a binder for spraying applications, and screen printing pastes for screen printing.

In aspects of the invention, the braze filler metals which contain chromium may be used for repairing heat exchangers, or in the production of heat exchangers by brazing the exchanger with an iron-based brazing filler metal or alloy. The braze filler alloys or metals may be used for brazing or production of Exhaust Gas Recirculation Coolers (EGR coolers) that aid in reducing nitrogen oxide emissions (NOx) for internal combustion engines, and other devices which are employed in high temperature corrosive environments.

Embodiments are directed to an iron-based braze filler alloy includes
a) nickel in an amount of from 0 wt % to 35 wt %,
b) chromium in an amount of from 0 wt % to 25 wt %,
c) silicon in an amount of from 4% wt % to 9% wt %,
d) phosphorous in an amount of from 5 wt % to 11 wt %,
e) boron in an amount of from 0 wt % to 1 wt %, and
f) the balance being iron,
   the percentages of a) to f) adding up to 100 wt %, and wherein the total amount of iron, nickel, and chromium is from 84 wt % to 90 wt %, the ratio of a/(a+f) is from 0 to 0.5, and the ratio of b/(a+b+f) is from 0 to 0.33, wherein the iron-based braze filler alloy has a brazing temperature of less than 1,100° C., and wherein the iron-based braze filler alloy has at least one of: a solidus temperature which is less than or equal to 1,030° C., a liquidus temperature which is less than or equal to 1,075° C., or a melting range where the difference between the solidus temperature and the liquidus temperature is less than 85° C.

In embodiments, the iron-based braze filler alloy is a ternary alloy FeSiP wherein the amount of iron is from 84 wt % to 90 wt %, the percentages of [a)+c)+d)] adding up to 100 wt %, and said melting range is less than or equal to 25° C.

In still other embodiments, the amount of nickel is from 25 wt % to 35 wt %, the percentages of a) to f) adding up to 100 wt %.

According to other embodiments, the amount of chromium is from 18 wt % to 25 wt %, the percentages of a) to f) adding up to 100 wt %.

In accordance with still other embodiments, the amount of boron is greater than 0 wt % but less than 1 wt %, the percentages of a) to f) adding up to 100 wt %.

In other embodiments, the amount of boron is from 0.1 wt % to 0.5 wt %, the percentages of a) to f) adding up to 100 wt %.

According to other embodiments:
a) the nickel is in an amount of from 25 wt % to 35 wt %,
b) the chromium is in an amount of from 18 wt % to 25 wt %,
c) the silicon is in an amount of from 4 wt % to 9 wt %,
d) the phosphorous is in an amount of from 5 wt % to 11 wt %, and
e) the boron is in an amount of from 0.1 wt % to 0.5 wt % and
f) the balance is iron.

In still other embodiments:
a) the nickel is in an amount of from 28 wt % to 33 wt %,
b) the chromium is in an amount of from 18 wt % to 22 wt %,
c) the silicon is in an amount of from 4.5 wt % to 6 wt %,
d) the phosphorous is in an amount of from 6 wt % to 10 wt %, and
e) the boron is in an amount of from 0.1 wt % to 0.5 wt % and
f) the balance is iron.

According to other embodiments, the boron is in an amount of from 0.3 wt % to 0.4 wt %.

In accordance other embodiments, the iron content is 29 wt % 40 wt %.

In other embodiments, the solidus temperature is less than or equal to 1,000° C.

In still other embodiments, the solidus temperature is less than or equal to 975° C.

According to still other embodiments, the liquidus temperature is less than 1,050° C.

According to embodiments, the difference between the solidus temperature and the liquidus temperature is less than 50° C.

In other embodiments, the iron-based braze filler alloy has a brazing temperature of less than 1,060° C.

Moreover, the iron-based braze filler alloy is in the form of a powder, amorphous foil, atomized powder, paste, tape, or sintered preform.

In accordance with still other embodiments, a powder spray coating includes the iron-based braze filler alloy and a binder.

According to other embodiments, a heat exchanger includes the above-described iron-based braze filler alloy.

In accordance with still other embodiments, the heat exchanger is an Exhaust Gas Recirculation Cooler (EGR cooler) that aids in reducing nitrogen oxide emissions (NOx) for internal combustion engines.

In accordance with still yet other embodiments, a method for producing or repairing a heat exchanger includes brazing the exchanger with the above-described iron-based braze filler alloy.

### BRIEF DESCRIPTION OF THE DRAWINGS

The present invention is further illustrated by the accompanying drawings wherein:

FIG. 1 is a Differential Scanning calorimetry curve exhibiting a single peak in a heating and cooling cycle illustrating a near true eutectic melting behavior, with a narrow melting range of 19° C., and the solidus temperature and liquidus temperature for a ternary 86.2Fe-5.1Si-8.7P iron-based braze filler alloy of Example 1 of the present invention.

FIG. 2 is a Differential Scanning calorimetry curve exhibiting double peaks in a heating and cooling cycle illustrating a wide melting range of 102° C., and the solidus temperature and liquidus temperature of a filler metal with B and Mo, (50Fe-20Ni-12Cr-3Cu-3Mo-7P-4Si-1B), an iron-based braze filler alloy of Hong et al of Comparative Example 2.

### DETAILED DESCRIPTION OF THE INVENTION

An alloy starts to melt at one temperature called the solidus, and is not completely melted until it reaches a second higher temperature, the liquidus. As used herein the solidus is the highest temperature at which an alloy is solid—where melting begins. As used herein, the liquidus is the temperature at which an alloy is completely melted. At temperatures between the solidus and liquidus the alloy is part solid, part liquid. As used herein, the difference between the solidus and liquidus is called the melting range. As used herein, the brazing temperature is the temperature at which the iron-based braze filler alloy is used to form a braze joint. It is preferably a temperature which is at or above the liquidus, but it is below the melting point of the base metal to which it is applied. The brazing temperature is preferably 25° C. to 50° C. higher than the liquidus temperature of the iron-based braze filler alloy.

The melting range is a useful gauge of how quickly the alloy melts. Alloys with narrow melting ranges flow more quickly and when melting at lower temperatures, provide quicker brazing times and increased production. Narrow melting range alloys generally allow base metal components to have fairly tight clearances, for example 0.002″.

Filler alloys which have a wide melting range, which provides a wider temperature range between the solidus and liquidus where the filler metal is part liquid and part solid, may be suitable for filling wider clearances, or “capping” a finished joint. However, while helpful in bridging gaps, slowly heating a wide melting range alloy can lead to an occurrence called liquation. Long heating cycles may cause some element separation where the lower melting constituents separate and flow first, leaving the higher melting components behind. Liquation is often an issue in furnace brazing because extended heating time required to get parts to brazing temperature may promote liquation. A filler metal with a narrow melting range is preferred for this application. Even alloys with wide melting ranges, will melt quickly if they are applied at, or near, the liquidus, which is the temperature where the alloy is completely melted. The best capillary action and strongest brazed connections require close clearance between base metal parts. Accordingly, maintaining recommended clearance and brazing close to the liquidus temperature is preferred.

The solidus temperature, liquidus temperature, and melting range of the iron-based alloys are determined herein by Differential Scanning calorimetry (DSC) in accordance with the NIST practice guide, Boettinger, W. J. et al, “DTA and Heat-flux DSC Measurements of Alloy Melting and Freezing” National Institute of Standards and Technology, special Publication 960-15, November 2006, the disclosure of which is herein incorporated by reference in its entirety. In making the determinations the individual metallic powders are mixed and melted to form an alloy, the resulting alloy is solidified, the solidified alloy is ground to form a powdered alloy, and then the powdered alloy is subjected to the DSC analysis. The liquidus and solidus temperatures are determined by the profiles of the second heatings, which provides for better conformity of the alloy to the shape of the crucible, and more accurate determinations as indicated, for example, at page 12 of the NIST practice guide. The DSC analysis is performed using a STA-449 DSC of Netzsch (Proteus Software) with a 10° C./min heating rate from 700° C. to 1,100° C., or to a higher temperature as needed to exceed the liquidus temperature. From room temperature to 700° C., the differential scanning calorimeter heats at its faster programmed rate which usually takes about 20 minutes or about 35° C./min. The cooling rate employed for the DSC analysis from above the liquidus temperature back down to room temperature is also at 10° C./min, but other cooling rates may be used.

The present invention provides iron based braze filler metals or alloys that have low melting points and can be brazed below 1,100° C. They do not contain high amounts of boron which can cause erosion of base metals. The braze filler metals have sufficient high temperature corrosion resistance to withstand high temperature conditions of Exhaust Gas Recirculation Coolers (EGR coolers) which are devices that aid in reducing nitrogen oxide emissions (NOx) for internal combustion engines. The braze filler metals or alloys may be employed for brazing of catalytic converters for automobiles, heat exchangers, and other devices where, for example, brazing of thin base metals is needed.

In embodiments of the invention, iron-based braze filler metals or alloys are provided which are at or very close to the true eutectic point of the Fe—Si—P ternary system, which is the temperature at which the melting and solidification occur at a single temperature a for a pure element or compound, rather than over a range. The true ternary eutectic point of the Fe—Si—P system is difficult to determine because it must be determined using equilibrium conditions which can take days of testing to reach. In an aspect of the invention, after determining the lowest melting ternary eutectic point in the Fe—Si—P system, or as close to it as reasonably possible, as evidenced, for example, by a single peak in the DSC curve or a very narrow melting range, compositional adjustments are made with controlled additions of nickel and chromium to partly replace iron to gain high temperature corrosion resistance without any substantial increase of the melting point.

The silicon reduces the melting temperatures, and it cannot be readily diffused into the base metal as is boron. However, if too much silicon is included, it may increase brittleness and increase the liquidus temperature. The phosphorus increases wetting and flow behavior, but too much may increase brittleness, and weakness. The chromium improves corrosion resistance and increases melting temperatures, but the nickel decreases the melting temperatures. The nickel also improves both mechanical strength and corrosion resistance, with substantially lowering of the solidus and liquidus temperatures to achieve low brazing temperatures and strong bonding to the base metal, which is particularly important in thin-walled heat exchanger brazing operations and applications. Micro-alloying with small amounts of boron enables further improvement in brazeability and melting points of the iron-based braze filler metals or alloys without the deleterious effect of significant boride formation into the base metal.

Reducing the solidus temperature and the liquidus temperature to narrow the melting range of the iron-based braze filler metals or alloys provides compositions which behave more like a eutectic composition where there is no difference between the solidus and the liquidus temperatures. The narrowed down melting range provides alloys with brazing temperatures of less than 1,100° C., preferably less than 1,060° C., most preferably less than 1,050° C., with good wetting and spreading capabilities. In embodiments of the invention the iron-based braze filler metals or alloys exhibit narrow melting temperature ranges of less than 85° C., preferably less than or equal to 50° C., more preferably less than or equal to 25° C., and/or low solidus temperatures of less than or equal to 1,030° C., preferably less than or equal to 1,000° C., more preferably less than or equal to 975° C., and/or low liquidus temperatures of less than or equal to 1,075° C., preferably less than or equal to 1,050° C., even if two phases or two peaks are present, as determined by Differential Scanning calorimetry (DSC).

It not necessary to limit the chromium content, and to compensate with the addition of Cu, Mo, Ti, or rare earth elements to increase corrosion resistance, improve bonding strength, or obtain joints with high ductility. While copper may reduce melting temperatures slightly, molybdenum is a refractory metal which substantially increases melting points.

The iron-based braze filler alloy or metals of the present invention comprise:
a) nickel in an amount of from 0 wt % to 35 wt %, generally at least 10 wt %, for example from 25 wt % to 35 wt %, preferably from 28 wt % to 33 wt %, more preferably from 29 wt % to 32 wt %, most preferably from 29 wt % to 31 wt %,
b) chromium in an amount of from 0 wt % to 25 wt %, generally at least 10 wt %, for example from 18 wt % to 25 wt %, preferably from 18 wt % to 23 wt %, more preferably from 18 wt % to 22 wt %, for example, from 19 wt % to 21 wt %,
c) silicon in an amount of from 4 wt % to 9 wt %, for example from 4 wt % to 6 wt %, preferably from 4.5 wt % to 6 wt %, more preferably from 5 wt % to 6 wt %,
d) phosphorous in an amount of from 5 wt % to 11 wt %, preferably from 5 wt % to 10 wt %, more preferably from 6 wt % to 10 wt %,
e) boron in an amount of from 0 wt % to 1 wt %, preferably greater than 0 wt % but less than 1 wt %, for example from 0.1 wt % to 0.8 wt %, preferably from 0.1 wt % to 0.5 wt %, more preferably from 0.3 wt % to 0.5 wt %, for example from 0.3 wt % to 0.4 wt %, and
f) the balance being iron, for example from 29 wt % to 60 wt %, preferably from 29 wt % to 40 wt %, more preferably from 29 wt % to 35 wt %, most preferably from 29 wt % to 33 wt %,
   the percentages of a) to f) adding up to 100 wt %. The total amount of iron, nickel, and chromium is from 84% to 90 wt %, the ratio of a/(a+f) is from 0 to 0.5, for example from 0.2 to 0.5, preferably from 0.3 to 0.5, more preferably from 0.4 to 0.5, and the ratio of b/(a+b+f) is from 0 to 0.33, preferably from 0.1 to 0.3, more preferably from 0.15 to 0.3, for example from 0.20 to 0.26. The weight percentages are based upon the weight of the iron-based filler alloy.

In aspects of the invention where the iron-based filler alloy is a ternary system of iron, silicon, and phosphorous, the iron content ranges from 84 wt % to 90 wt %, the ratio of a/(a+f) is 0, and the ratio of b/(a+b+f) is also 0. The ternary alloy has a very narrow melting range, for example, less than or equal to 25° C., approaching the melting behavior of a eutectic composition where the solidus and the liquidus temperatures are the same.

In aspects of the invention, the iron-based braze filler alloy has solidus temperatures of less than 975° C. and liquidus temperatures of less than 1,050° C. when:
a) the nickel is in an amount of from 25 wt % to 35 wt %,
b) the chromium is in an amount of from 18 wt % to 25 wt %,
c) the silicon is in an amount of from 4 wt % to 9 wt %,
d) the phosphorous is in an amount of from 5 wt % to 11 wt %,
e) the boron is in an amount of from 0.1 wt % to 0.5 wt %, and
f) the balance being iron,
   the percentages of a) to f) adding up to 100 wt %.

In embodiments of the invention, the iron-based braze filler alloy or metal may be manufactured in the form of a powder, an amorphous foil, an atomized powder, a paste based on the powder, a tape based on the powder, sintered preforms, a powder spray coating with a binder, or a screen printing paste. The iron-based braze filler alloy or metal may be applied by spraying, or by screen printing.

In an additional aspect of the invention, a method is provided for producing or repairing a heat exchanger by brazing the exchanger with the iron-based braze filler alloy at a temperature of less than 1,100° C., preferably less than 1,060° C., more preferably less than 1,050° C.

The iron-based braze filler alloy or metal may be made using conventional methods for producing braze filler alloys or metals. For example, as conventional in the art, all of the elements or metals in the correct proportions may be mixed together and melted to form a chemically homogenous alloy which is atomized into a chemically homogeneous alloy powder. The particle size of the iron-based braze filler alloy or metal may depend upon the brazing method employed. Conventional particle size distributions conventionally employed with a given brazing method may be used with the iron-based braze filler alloy or metal of the present invention.

The base metal which is brazed with the iron-based braze filler alloy or metal may be any known or conventional material or article in need of brazing. Non-limiting examples of the base metal include alloys, or superalloys used in the manufacture of heat exchangers, Exhaust Gas Recirculation Coolers (EGR coolers), and other high temperature devices. Other non-limiting examples of known and conventional base metals which may be brazed with the iron-based braze filler alloy or metals of the present invention include carbon steel and low alloy steels, nickel and nickel alloys, stainless steel, and tool steels.

The present invention is further illustrated by the following non-limiting examples where all parts, percentages, proportions, and ratios are by weight, all temperatures are in ° C., and all pressures are atmospheric unless otherwise indicated:

### EXAMPLES

Examples 1-12 relate to iron-based braze filler alloys or metals of the present invention based upon a ternary Fe—Si—P system, with additions of Ni alone, Ni and Cr alone, and Ni and Cr and B, alone. Cu and Mo are not employed as they are in Hong, Li et al, “The effect of iron-based filler metal element on the properties of brazed stainless steel joints for EGR cooler application,” Welding in the World (2019) 63:263-275, published online Dec. 14, 2018. Comparative Examples 2-5 relate to iron-based braze filler metals of Hong et al which are Fe—Ni—Cr—Cu—Mo—P—Si alloys with or without B. Comparative Example 1 relates to Amdry 805 which is discussed in Hong et al, and is an Fe—Ni—Cr—Si—P iron-based braze filler alloy which does not contain Cu or Mo, and does not contain B, all of which are indicated in Hong et al as critical for a narrow melting range with a single peak, and for enabling brazing at a temperature of 1,050° C. The compositions of iron-based braze filler alloys or metals of the present invention and comparative iron-based braze filler alloys or metals with their solidus temperature, liquidus temperature and melting range, all determined by DSC in the same manner using the STA 449(DSC) of Netzsch, using a heating rate and a cooling rate of 10° C./min are shown in Table 1:

TABLE 1
Melting temperature of low melting Fe(Ni, Cr)—Si—P—B alloys

| | | | | | | | | | | | Melting |
|---|---|---|---|---|---|---|---|---|---|---|---|
| | Composition(wt %) | | | | | | | | M.P.(° C.) * | | Range |
| Example No. | Fe | Ni | Cr | B | P | Si | Cu | Mo | Solidus | Liquidus | (° C.) |
| (1) | 86.2 | — | — | — | 8.7 | 5.1 | — | — | 1024 | 1043 | 19 |
| (2) | 55.1 | 31.3 | — | — | 8.6 | 5.0 | — | — | 934 | 1007 | 73 |
| (3) | 33.6 | 31.8 | 20.8 | — | 8.7 | 5.1 | — | — | 1001 | 1042 | 41 |
| (4) | 31.7 | 32.1 | 21.1 | — | 9.4 | 5.7 | — | — | 1002 | 1027 | 25 |
| (5) | 31.8 | 31.7 | 21.2 | 0.1 | 9.5 | 5.7 | — | — | 974 | 1022 | 48 |
| (6) | 32.1 | 30.8 | 21.4 | 0.3 | 9.6 | 5.8 | — | — | 971 | 1008 | 37 |
| (7) | 32.4 | 30.1 | 21.5 | 0.5 | 9.6 | 5.8 | — | — | 963 | 1033 | 70 |
| (8) | 38.4 | 30.6 | 20.4 | 0.1 | 6.1 | 4.4 | — | — | 975 | 1044 | 69 |
| (9) | 38.8 | 29.7 | 20.6 | 0.3 | 6.1 | 4.5 | — | — | 965 | 1044 | 79 |
| (10) | 39.1 | 29.0 | 20.8 | 0.5 | 6.2 | 4.5 | — | — | 967 | 1038 | 71 |
| (11) | 36.4 | 31.3 | 20.5 | — | 7.3 | 4.4 | — | — | 1002 | 1059 | 57 |
| (12) | 37.2 | 29.3 | 21.0 | 0.5 | 7.5 | 4.5 | — | — | 976 | 1029 | 53 |
| Comparative 1 | 41 | 17.5 | 29 | — | 6.5 | 6 | — | — | 1055 | 1110 | 55 |
| Amdry 805 | | | | | | | | | | | |
| Comparative 2 | 50 | 20 | 12 | 1 | 7 | 4 | 3 | 3 | 905 | 1007 | 102 |
| Hong et al | | | | | | | | | | | |
| Comparative 3 | 50.25 | 20 | 12 | 0.75 | 7 | 4 | 3 | 3 | 902 | 1013 | 111 |
| Hong et al | | | | | | | | | | | |
| Comparative 4 | 50.75 | 20 | 12 | 0.25 | 7 | 4 | 3 | 3 | 970 | 1034 | 64 |
| Hong et al | | | | | | | | | | | |
| (BJUT-Fe) | | | | | | | | | | | |
| Comparative 5 | 51 | 20 | 12 | 0 | 7 | 4 | 3 | 3 | 990 | 1046 | 56 |
| Hong et al | | | | | | | | | | | |

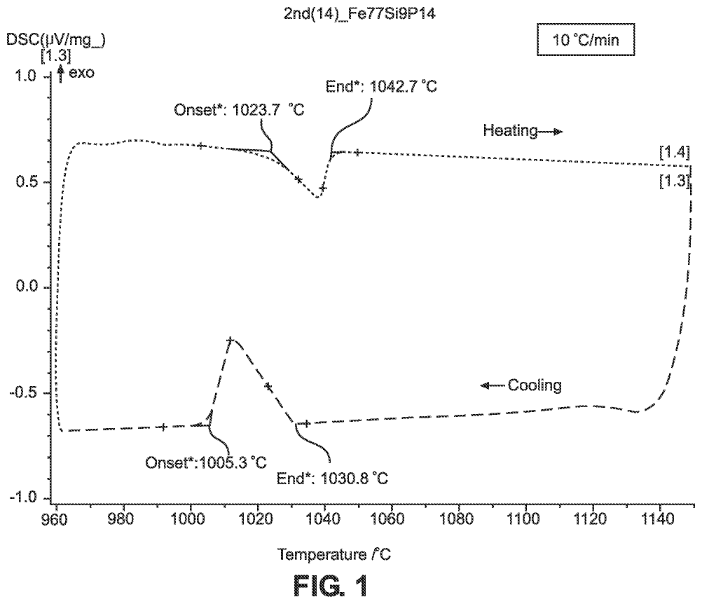

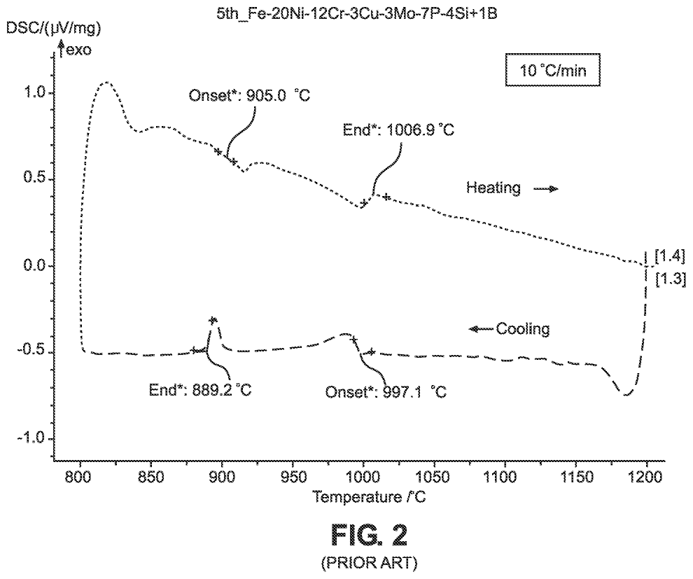

Example 1 is a ternary 86.2Fe-5.1Si-8.7P iron-based braze filler alloy of the present invention. As shown in FIG. 1, the Differential Scanning calorimetry curve for the ternary alloy of Example 1 exhibits a single peak in a heating and cooling cycle indicating a near true eutectic melting behavior, with a narrow melting range of 19° C., and a solidus temperature of 1,024° C. and a liquidus temperature of 1,043° C. FIG. 2 (Prior Art) is a Differential Scanning calorimetry curve exhibiting double peaks in a heating and cooling cycle illustrating a wide melting range of 102° C., with a solidus temperature of 905° C. and a liquidus temperature of 1,007° C. for a filler metal with Cu and Mo, and B (50Fe-20Ni-12Cr-3Cu-3Mo-7P-4Si-1B), an iron-based braze filler metal of Hong et al of Comparative Example 2.

The data listed in Table 1 show that the iron-based braze filler alloys of the present invention, Examples 1-12 exhibit: a) unexpectedly low solidus temperatures of less than 1,030° C., ranging from 934° C. to 1,024° C., b) unexpectedly low liquidus temperatures of less than 1,050° C., ranging from 1,007° C. to 1,043° C., c) unexpectedly low melting ranges of less than 85° C., the melting ranges ranging from 19° C. for Example 1 to 79° C. for Example 9, and d) unexpectedly low brazing temperatures of less than 1,100° C., with no or very small amounts of boron, and without the need for copper or molybdenum as in Comparative Examples 2-5.

Also, substantially higher amounts of nickel ranging from 29.0 to 32.1 wt % in Examples 2 through 12, compared to the 20% by weight in Comparative Examples 2-5 and 17.5% by weight in Comparative Example 1 provides both improved mechanical strength and corrosion resistance, with substantial lowering of the solidus and liquidus temperatures to achieve low brazing temperatures and strong bonding to the base metal, which is particularly important in thin-walled heat exchanger brazing operations and applications. The substantially higher amounts of chromium ranging from 20.4% by weight to 21.4% by weight in Examples 3 through 12, compared to the 12% by weight in Comparative Examples 2-5 provides improved corrosion resistance and increases melting temperatures, but the nickel decreases the melting temperatures.

Also, where no boron, copper or molybdenum are employed, as in Examples 1-4 and 11: a) the solidus temperature ranges from 934° C. to 1,024° C. whereas in Comparative Example 1 (Amdry 805), the solidus temperature of 1,055° C. is at least 31° C. higher, and b) the liquidus temperature ranges from 1,007° C. to 1,059° C. whereas in Comparative Example 1 (Amdry 805), the liquidus temperature of 1,110° C. is at least 51° C. higher which would indicate the need for a brazing temperature which is at least 51° C. higher. Where boron is employed, but copper and molybdenum are not employed, as in Examples 5-10 and 12: a) the solidus temperature ranges from 963° C. to 976° C. whereas in Comparative Example 1 (Amdry 805), the solidus temperature of 1,055° C. is at least 79° C. higher, and b) the liquidus temperature ranges from 1,022° C. to 1,044° C. whereas in Comparative Example 1 (Amdry 805), the liquidus temperature of 1,110° C. is at least 66° C. higher which would indicate the need for a brazing temperature which is at least 66° C. higher.

Further, at least because the invention is disclosed herein in a manner that enables one to make and use it, by virtue of the disclosure of particular exemplary embodiments, such as for simplicity or efficiency, for example, the invention can be practiced in the absence of any step, additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An iron-based braze filler alloy comprising:
a) nickel in an amount of from 0 wt % to 35 wt,
b) chromium in an amount of from 0 wt % to 25 wt %,
c) silicon in an amount of from 4% wt % to 9% wt %,
d) phosphorous in an amount of from 5 wt % to 11 wt %,
e) boron in an amount of from 0 wt % to 1 wt %, and
f) the balance being iron,
the percentages of a) to f) adding up to 100 wt %, and
wherein the total amount of iron, nickel, and chromium is from 84 wt % to 90 wt, the ratio of a/(a+f) is from 0 to 0.5, and the ratio of b/(a+b+f) is from 0 to 0.33,
wherein the iron-based braze tiller alloy has a brazing temperature of less than 1,100° C., and
wherein the iron-based braze filler alloy has at least one of:
a solidus temperature which is less than or equal to 1,030° C.,
a liquidus temperature which is less than or equal to 1,075° C., or
a melting range where the difference between the solidus temperature and the liquidus temperature is less than 85° C.

2. The iron-based braze filler alloy as claimed in claim 1 which is a ternary alloy FeSiP wherein the amount of iron is from 84 wt % to 90 wt %, the percentages of [a)+c)+d)] adding up to 100 wt %, and said melting range is less than or equal to 25° C.

3. The iron-based braze filler alloy as claimed in claim 1 wherein the amount of nickel is from 25 wt % to 35 wt %, the percentages of a) to f) adding up to 100 wt %.

4. The iron-based braze filler alloy as claimed in claim 1, wherein the amount of chromium is from 18 wt % to 25 wt %, the percentages of a) to f) adding up to 100 wt %.

5. The iron-based braze filler alloy as claimed in claim 1, wherein the amount of boron is greater than 0 wt % but less than 1 wt %, the percentages of a) to f) adding up to 100 wt %.

6. The iron-based braze filler alloy as claimed in claim 5 wherein the amount of boron is from 0.1 wt % to 0.5 wt %, the percentages of a) to f) adding up to 100 wt %.

7. The iron-based braze filler alloy as claimed in claim 1 wherein:
a) the nickel is in an amount of from 25 wt % to 35 wt %,
b) the chromium is in an amount of from 18 wt % to 25 wt %,
c) the silicon is in an amount of from 4 wt % to 9 wt %,
d) the phosphorous is in an amount of from 5 wt % to 11 wt %, and
e) the boron is in an amount of from 0.1 wt % to 0.5 wt % and
f) the balance is iron.

8. The iron-based braze filler alloy as claimed in claim 1 wherein:
a) the nickel is in an amount of from 28 wt % to 33 wt %,
b) the chromium is in an amount of from 18 wt % to 22 wt %,
c) the silicon is in an amount of from 4.5 wt % to 6 wt %,
d) the phosphorous is in an amount of from 6 wt % to 10 wt %, and
e) the boron is in an amount of from 0.1 wt % to 0.5 wt % and
f) the balance is iron.

9. The iron-based braze filler alloy as claimed in claim 1, wherein the boron is in an amount of from 0.3 wt % to 0.4 wt %.

10. The iron-based braze filler alloy as claimed in claim 1, wherein the iron content is 29 wt % 40 wt %.

11. The iron-based braze filler alloy as claimed in claim 1, wherein the solidus temperature is less than or equal to 1,000° C.

12. The iron-based braze filler alloy as claimed in claim 6 wherein the solidus temperature is less than or equal to 975° C.

13. The iron-based braze filler alloy as claimed in claim 1, wherein the liquidus temperature is less than 1,050° C.

14. The iron-based braze filler alloy as claimed in claim 1, wherein the difference between the solidus temperature and the liquidus temperature is less than 50° C.

15. The iron-based braze filler alloy as claimed in claim 1 having a brazing temperature of less than 1,060° C.

16. The iron-based braze filler alloy as claimed in claim 1, which is in the form of a powder, amorphous foil, atomized powder, paste, tape, or sintered preform.

17. A powder spray coating comprising the iron-based braze filler alloy as claimed in claim 1 and a binder.

18. A heat exchanger comprising an iron-based braze filler alloy as claimed in claim 1.

19. The heat exchanger as claimed in claim 18, which is an Exhaust Gas Recirculation Cooler (EGR cooler) that aids in reducing nitrogen oxide emissions (NOx) for internal combustion engines.

20. A method for producing or repairing a heat exchanger comprising brazing the exchanger with an iron-based braze filler alloy as claimed in claim 1.
